(19) United States
(12) Patent Application Publication
(10) Pub. No.: US 2013/0327249 A1
(43) Pub. Date: Dec. 12, 2013

(54) ELECTRODES FOR LITHIUM BATTERIES

(71) Applicants: Martin Winter, Munster (DE); Sangsik Jeong, Munster (DE); Stefano Passerini, Munster (DE)

(72) Inventors: Martin Winter, Munster (DE); Sangsik Jeong, Munster (DE); Stefano Passerini, Munster (DE)

(73) Assignees: ROCKWOOD LITHIUM GMBH, Frankfurt am Main (DE); EVONIK LITARION GMBH, Kamenz (DE); VOLKSWAGEN AKTIENGESELLSCHAFT, Wolfsburg (DE)

(21) Appl. No.: 13/993,753

(22) PCT Filed: Dec. 20, 2011
(86) PCT No.: PCT/EP2011/073312

§ 371 Date: Aug. 28, 2013

(30) Foreign Application Priority Data
Dec. 22, 2010 (DE) 10 2010 061 485.8

(51) Int. Cl. H01M 4/62

(52) U.S. Cl. CPC H01M 4/622
USPC 106/163.01; 536/56; 427/58

(57) ABSTRACT

Cathode or anode, wherein the cathode binder or the anode binder comprises or consists of cellulose and/or cellulose derivatives which are soluble only in ionic liquids, a process for the production thereof and the use of cellulose and/or cellulose derivatives which are soluble only in ionic liquids as binder for producing cathodes and anodes, in particular battery electrodes.

The present application claims the priority of DE 10 2010 061 485.8.

The priority document is incorporated by reference in its entirety into the present disclosure.

All documents cited in the present application are incorporated by reference in their entirety into the present disclosure.

The present invention relates to improving the environmental friendliness of battery electrodes and lithium batteries which use these, an environmentally friendly process for producing battery cathodes and anodes and batteries containing one or more of these components.

The present invention applies in particular to electrodes for lithium batteries, which electrodes comprise cellulose, preferably natural cellulose, and/or cellulose derivatives which are soluble in ionic liquids, a process for producing these electrodes and their use.

### PRIOR ART

The demand for portable electronic appliances, for example personal digital assistants (PDAs), cell phones and notebook computers is always increasing. The necessity of designing these portable appliances so that they are ever more compact, thinner and lighter is likewise increasing. Apart from this already very comprehensive and continually growing market, it appears that vehicles based on hybrid drives are in a very advanced state of development and will continue to be used to an increasing extent. Accordingly, batteries which supply these appliances with power are ever more important constituents of these appliances. Lithium batteries in particular have hitherto been used as main power source for such portable appliances and are considered to be the only possibility for supply of power to hybrid, plug-in hybrid (charging of the battery also at a power point) and completely electric vehicles since they are very light and have a high energy density.

Lithium batteries comprise, inter alia, active cathode materials, active anode materials and separators. For example, active cathode materials and active anode materials which can be used for lithium batteries are known from U.S. Pat. No. 5,837,015, U.S. Pat. No. 5,635,151. Active cathode materials for lithium batteries can be made up of lithium-containing transition metal oxides, for example LiCoO₂, LiMnO₂, LiNiO₂ and binary or ternary compounds (LiCo_{(1-x-y)}NiₓMn_{y}O₂), chalcogen compounds such as MoS₂ and metal phosphates such as LiFePO₄. Since these compounds have a layer-like crystal structure, lithium ions can be reversibly intercalated/deintercalated into/from these structures. For this reason, these compounds are often used as active cathode materials for lithium batteries.

The active anode material can be metallic lithium, but acicular lithium dendrites can then grow on the surface of the lithium. This can happen when the lithium is repeatedly dissolved and reprecipitated during the charging/discharging processes of a battery. As a result, the acicular dendrites can have an adverse effect on the discharging/charging efficiency and may even bring about internal short circuits by contact with the cathode. To counter these problems, a material which reversibly intercalates and deintercalates lithium ions can be used as anode material. This material can be a lithium alloy, a metal powder, a graphitic or carbon-containing material, metal oxides or metal sulfides.

A binder is necessary in order to bind pulverulent electrode materials to the electric power outlet leads and form sheet-like electrodes.

Up to now, lithium battery electrodes and separators were produced using synthetically prepared polymers such as PE (polyethylene), PP (polypropylene), PEO (polyethylene oxide), PPO (polypropylene oxide), PTFE (polytetrafluoroethylene), PMMA (polymethyl methacrylate), PAN (polyacrylonitrile), PS (polystyrene), SBR (styrene-butadiene rubber) and many others, in each case either alone or in mixtures of these materials. Nevertheless, PVdF (polyvinylidene difluoride, either as such or as copolymer, then normally PVdF-HFP, where HFP is hexafluoropropylene) has hitherto been the far most widely used binder. Most of these binders require the use of volatile organic solvents such as N-methyl-2-pyrrolidone (NMP) which are toxic to human beings and are anything but environmentally friendly. The result is that the production process is very complex and requires a very high outlay in terms of apparatus. To counter these problems, the Japanese published specification JP 05-074461 discloses a process for producing an aqueous slurry of active anode material using a styrene-butadiene rubber (SBR)-based binder and a carboxymethylcellulose (CMC)-based binder. In this case, water was used as solvent. Furthermore, US 2005 074669 A1 discloses the influence of carboxyl substitution in the CMC binder on the performance of lithium batteries produced using anodes which have been produced using this binder.

Carboxymethylcellulose or CMC, viz. a cellulose derivative having carboxymethyl groups (—CH₂—COOH) which are bound to some of the hydroxyl groups of the cellulose backbone, is prepared by alkali-catalyzed reaction of cellulose with chloroacetic acid. However, this process is expensive and requires the use of toxic chemicals.

Cellulose, on the other hand, is an environmentally friendly binder which requires no further chemical treatment (apart from removal of the residues of its plant sources). Cellulose is the most abundant organic compound on earth. Approximately 33% of all plant material is cellulose (up to 90% in cotton and 50% in wood). Additionally, it can be obtained from virtually any plant.

### OBJECT

It is an object of the present invention to avoid the disadvantages of the prior art. In particular, more environmentally friendly binders for pulverulent anode and/or cathode materials and production processes for anodes and cathodes using these binders should be found.

### Achievement of the Object:

This object is achieved by cathodes or anodes, where the cathode or anode binder comprises or consists of cellulose, preferably natural cellulose, and/or cellulose derivatives which are soluble in ionic liquids, a process for producing them and the use of natural cellulose as binder for producing cathodes and anodes, in particular battery electrodes.

### DEFINITION OF TERMS

For the purposes of the present invention, all amounts indicated are by weight, unless indicated otherwise.

For the purposes of the present invention, the term “room temperature” means a temperature of 20° C. Temperatures indicated are in degrees Celsius (° C.), unless indicated otherwise.

Unless indicated otherwise, the reactions or process steps indicated are carried out at normal pressure/atmospheric pressure, i.e. at 1013 mbar.

For the purposes of the present invention, the term “composites” refers to physical and/or chemical mixtures or compounds of materials.

The term “ionic liquid” refers, for the purposes of the present invention, to liquids consisting exclusively of cations and anions. These have low melting points below 100° C. The ionic liquids have virtually no vapor pressure at room temperature. The size and symmetry of the participating ions prevents the formation of a strong crystal lattice.

Even little thermal energy is sufficient to overcome the lattice energy and break up the solid crystal structure. In particular, ionic liquids are, for the purposes of the present invention, materials which are liquid at temperatures in the range from −10 to 80° C., in particular at room temperature.

For the purposes of the present invention, the term “natural cellulose” as distinct from fully synthetic cellulose which can also be used according to the invention refers to cellulose from various natural sources, in particular from cotton, flax, ramie, bamboo, straw, bacteria, wood, bagasse.

### DETAILED DESCRIPTION

The present invention relates to an environmentally friendly process for producing cathodes and anodes, in which cellulose is used as binder, and lithium batteries containing all or some of these components. The present invention is directed in particular to the use of natural cellulose as binder for producing battery electrodes. The natural cellulose is for this purpose dissolved in fully recyclable ionic liquids. After the cellulose-based electrode slurries have been applied to substrates which conduct away electrons, the ionic liquids are removed by means of a phase inversion process using water (or C₁-C₅-alcohols) as cosolvents. As a result, it is possible to produce battery electrodes without the necessity of using environment-polluting volatile organic compounds (VOC). These components can be used for producing lithium batteries having excellent characteristics.

The present invention accordingly provides cathodes and anodes, wherein natural cellulose is used as binder, preferably battery electrodes, and batteries, in particular lithium batteries, containing all or some of these components.

The present invention accordingly also provides a process for producing cathodes and anodes, in particular battery electrodes, wherein
a) natural cellulose is dissolved
   i) in a fully recyclable ionic liquid or
   ii) in a mixture of fully recyclable ionic liquids or
   iii) in a mixture of at least one fully recyclable ionic liquid and water,
b) the cellulose-based electrode slurries are then applied to substrates which conduct away electrons, in particular power outlet foils, or pasted into power outlet meshes or foams,
c) the ionic liquids are removed by means of a phase inversion process using water (or natural alcohols) as cosolvents.

For the purposes of the present invention, fully recyclable means that the ionic liquids can be separated off from the other materials by conventional measures in the art, for example filtration, distillation or the like, and recovered to an extent of at least 90% by weight, preferably at least 95% by weight, in particular at least 98% by weight, in a purity of at least 90%, preferably at least 95%, in particular at least 98%, where the purity is the content of ionic liquid(s) relative to other materials which are not ionic liquids.

The present invention further provides for the use of natural cellulose as binder for producing cathodes and anodes, in particular battery electrodes.

It has surprisingly been found in the context of the present invention that battery cathodes and anodes in which natural cellulose is used as binder function just as well as battery cathodes and anodes produced using conventional binders, even though cellulose has more OH groups which are considered to be relatively unstable in the voltage range of a lithium battery.

The anodes and cathodes of the invention can be used to produce batteries, in particular lithium batteries, which have state-of-the-art characteristics but additionally have the advantage of easier recyclability. This is because the binder can be removed at the end of the lifecycle of the battery by simple pyrolysis of the electrode. The pyrolysis of cellulose leads, in production, only to carbon dioxide and water which do not damage the environment.

An embodiment of the present invention encompasses lithium battery cathodes and anodes containing cellulose as binder. Furthermore, the present invention encompasses, in a further embodiment, a lithium battery containing one or both of the abovementioned lithium battery components.

In a preferred aspect of the present invention, the cellulose binder used in the lithium battery components is produced by dissolution in an ionic liquid (or in a mixture of ionic liquids or in a mixture of ionic liquid and water) and precipitated by means of a phase inversion process in which water (or alcohol) is used as cosolvent.

In an embodiment of the present invention, a lithium battery cathode is produced using cathode-forming materials and cellulose.

A cathode plate according to the invention can be produced by dissolving natural cellulose in an ionic liquid or a mixture of ionic liquids or a mixture of ionic liquid and water.

After dissolution of the binder, the active cathode material and optionally a conductive material are added and the cathode slurry is obtained by stirring. The slurry is then applied to a power outlet foil, where the foil can be a metal foil, an electrically conductive polymer film or a metal foil or electrically conductive polymer film coated with carbon, preferably selected from the group consisting of an aluminum foil, a nickel foil, a titanium foil, a stainless steel foil, a carbon-coated aluminum foil, a carbon-coated nickel foil, a carbon-coated titanium foil, a carbon-coated stainless steel foil. The slurry applied to the foil is then subjected to a phase inversion process using water as cosolvent in order to remove the ionic liquid from the cathode coating. Ionic liquids are very hydrophilic and when the coated electrodes are immersed the ionic liquid migrates into an aqueous phase.

Furthermore, in a variant of the present invention, C₁-C₅-alcohols, preferably selected from the group consisting of methanol, ethanol, all isomers of propanol, all isomers of butanol, all isomers of pentanol and mixtures thereof, can be used as cosolvents as an alternative to or together with water.

The phase inversion process comprises introducing the coated cathode into deionized water.

Here, the coated electrode is dipped into an aqueous phase, resulting in the ionic liquid migrating, because of its high hydrophilicity, into the water.

Phase inversion processes are generally known and do not have to be described in detail here; use examples may be found, for example, in Du Pasquier et al., 2000, Solid State Ionics 135, 249-257 or DE 10 2008 041 477 A1.

This process can be repeated a number of times. The ionic liquid can be completely recovered from the aqueous solution by subjecting the aqueous solution to filtration (in order to remove the solid particles which may have been formed in the phase inversion process) and subsequently evaporating the water, in particular by use of a rotary evaporator.

After removal of the ionic liquid, the coated cathode is dried in order to form a cathode plate.

In particular, the cathode-forming materials can contain an active cathode material which comprises lithium iron phosphate (LiFePO₄) but is not restricted thereto and a conductive material.

As conductive material, it is possible to use all conductive materials which are known to those skilled in the art and are normally used in batteries, preferably materials based on carbon black, graphite or metal, particularly preferably selected from the group consisting of graphite, nickel, aluminum, titanium and mixtures thereof.

For the purposes of the present invention, the active cathode material can preferably be selected from the group consisting of

lithium composite oxides, preferably of the formula Li_{w}AₓB_{y}C_{z}Oᵥ, where A, B, C are selected from the group consisting of Mn, Co, Ni, Mg, Zn, Cu, Ga, Al, Cr, Ge, Sn, Nb, Ta, V and Ti, w, x, y, z=0−1, x+y+z=1 and v=0-3,
lithium composite phosphates, preferably of the formula Li_{w}AₓB_{y}C_{z}(PO)₄, where A, B, C are selected from the group consisting of Fe, Co, Ni, Mn, Mg, Zn, Cu, Ga, Al, Cr, Ge, Sn, Nb, Ta, V and Ti, w, x, y, z=0−1, x+y+z=1,
lithium composite silicates, preferably of the formula Li_{2w}AₓB_{y}C_{z}(SiO)₄, where A, B, C are selected from the group consisting of Co, Ni, Mn, Mg, Zn, Cu, Ga, Al, Cr, Ge, Sn, Nb, Ta, V and Ti, w, x, y, z=0−1, x+y+z=1,
single substance sulfur (elemental sulfur),
catholytes in which Li₂Sₙ, where n>=1, is dissolved, preferably selected from the group consisting of Li₂S, Li₂S₂, Li₂S₄, Li₂S₆, Li₂S₈ and mixtures thereof,
organosulfur, preferably CₓH₂ₓS, where 1≦x≦5,
and (C₂Sₓ)_{y}, where 2.5<=x<=20 and y>=2,
bromine, iodine and mixtures thereof.

In a particularly preferred variant of the present invention, the active cathode material is LiFePO₄.

Further cathode materials which can be used in a variant of the present invention are those customarily used in the prior art.

Thus, for example, in Science and Technology of Lithium batteries, Kluwer Academic Publishers 311, Chapter 11 by M. Pasquali, S. Passerini and G. Pistoia, the following: LiMn₂₋ₓMₓO₄, where x=0.5, LiNiO₂, LiCoO₂, LiCo_{1-x-y}NiₓM_{y}O₂, LiMn₂O₄, Li_{1+y}Mn₂₋ₓMₓO₄, LiMnO₂, LiₓMn_{1-y}M_{y}O₂, Li[LiₓM_{y}Mn_{1-x-y}]O₂, LiFePO₄, Mn spinels, LiₓMnO₂, LiₓV_{y}O_{z}, sulfur, polysulfides, FeS₂.

A lithium battery cathode current collector (cathode plate) according to the present invention can be made up of any electronic conductor which is not chemically reactive in a battery. For example, the current collector can be made of stainless steel, Ni, Al, Ti or C. The surface of the stainless steel can be coated with C, Ni, Ti or Ag.

The cathodic current collector can preferably consist of aluminum or an aluminum alloy, preferably of aluminum.

The amount of cellulose binder can vary in the range 0.1-40% by weight, preferably 1-35% by weight, particularly preferably 5-25% by weight, based on the complete cathode composition. In this case, the complete cathode composition can comprise the active cathode material, a conductive material, and the cellulose binder.

In a further embodiment of the present invention, a lithium battery anode is produced using anode-forming materials and cellulose.

An anode plate can be produced by dissolving natural cellulose in an ionic liquid or a mixture of ionic liquid and water.

After dissolution of the binder, the active anode material and optionally conductive material are added in order to produce the anode slurry by stirring. The slurry is then applied to a foil, where the foil can be a metal foil, an electrically conductive polymer film or a carbon-coated metal foil or polymer film, preferably selected from the group consisting of a copper foil, a nickel foil, a stainless steel foil, a carbon-coated copper foil, a carbon-coated nickel foil, a carbon-coated stainless steel foil.

The applied slurry is then subjected to a phase inversion process using water as cosolvent in order to remove the ionic liquid from the anode coating.

Furthermore, in a variant of the present invention, C₁-C₅-alcohols can be used as cosolvents as an alternative to or together with water, preferably alcohols selected from the group consisting of methanol, ethanol, all isomers of propanol, all isomers of butanol, all isomers of pentanol and mixtures thereof.

The phase inversion process comprises introducing the coated anode into deionized water.

Here, the coated electrode is dipped into an aqueous phase, with the ionic liquid migrating, owing to its high hydrophilicity, into the water.

This process can be repeated a number of times. The ionic liquid can be completely recovered from the aqueous solution by filtration (in order to remove solid particles which may have been formed during the phase inversion process) and evaporation of the water, in particular by means of a rotary evaporator. After removal of the ionic liquid, the coated anode can be dried in order to form an anode plate.

In particular, the anode-forming materials can comprise an active anode material which can comprise a carbon-containing material and a conductive material but is not limited thereto.

As conductive material, it is possible to use all conductive materials which are known to those skilled in the art and are normally used in batteries, preferably materials based on conductive carbon black, graphite or metal powders or whiskers, particularly preferably selected from the group consisting of graphite, nickel, aluminum, titanium and mixtures thereof.

For the purposes of the present invention, the active anode material is preferably selected from the group consisting of
carbon-containing material such as natural graphite, synthetic graphite, coke, carbon fibers,
an element selected from the group consisting of Al, Si, Sn, Ag, Bi, Mg, Zn, In, Ge, Pb, Ti and mixtures thereof which can form an alloy with Li,
a compound containing at least one element selected from the group consisting of Al, Si, Sn, Ag, Bi, Mg, Zn, In, Ge, Pb, Ti and mixtures thereof, which compound can form an alloy with lithium,
a composite compound consisting of two or more elements selected from the group consisting of Al, Si, Sn, Ag, Bi, Mg, Zn, In, Ge, Pb, Ti, carbon,
a lithium-containing nitrite,
a lithium composite oxide, preferably of the formula Li_{w}AₓB_{y}C_{z}Oᵥ, where A, B, C are selected from the group consisting of Al, Si, Sn, Ag, Bi, Mg, Zn, In, Ge, Pb, Ti and mixtures, w, x, y, z=0-1, x+y+z=1 and v=0-3,
a lithium composite vanadate, preferably of the formula Li_{w}AₓB_{y}C_{z}(VO)₄, where A, B, C are selected from the group consisting of Al, Si, Sn, Ag, Bi, Mg, Zn, In, Ge, Pb, Ti and mixtures, w, x, y, z=0−1, x+y+z=1,
   or mixtures thereof.

A lithium battery anode current collector according to the present invention can be made of any electric conductor which is not chemically reactive in a battery. For example, the current collector can be made of stainless steel, Ni, Cu, Ti or C. The surface of the stainless steel can be coated with C, Ni, Ti or Ag.

In particular, the anodic current collector can be made of copper or of a copper alloy, in particular of copper. The amount of cellulose binder can vary in the range 0.1-40% by weight, preferably 1-35% by weight, particularly preferably 5-25% by weight, based on the complete anode composition. In this context, the total anode composition can comprise the active anode material, a conductive material and the cellulose binder.

In particular, the solvent for the cellulose can, for the purposes of the present invention, be 1-ethyl-3-methylimidazolium acetate (for the purposes of the present invention also abbreviated as EMIAc), but is not restricted thereto. Further ionic liquids which can be used for this purpose are, in particular, EMI⁺H₂PO₂⁻ and all 1-alkyl-3-methylimidazolium acetate compounds.

Examples of compounds which can be used in one variant of the present invention may be found in DE 10 2005 017 715 A1, DE 10 2005 062 608 A1, DE 10 2006 042 892 A1, WO 2008/119770 A1.

A process for preparing a lithium battery according to the present invention will be described below.

The lithium salt used in the lithium battery according to the invention can consist of any lithium compound which dissolves in organic solvents to form lithium ions. The lithium compound is, for the purposes of the present invention, preferably selected from the group consisting of lithium perchlorate (LiClO₄), lithium tetrafluoroborate (LiBF₄), lithium hexafluorophosphate (LiPF₆), lithium trifluoromethanesulfonate (LiCF₃SO₃), lithium bis(trifluoromethanesulfonyl)amide (LiN(CF₃SO₂)₂) and mixtures thereof.

The concentration of the lithium salt can, for the purposes of the present invention, vary in the range 0.5-2 mol per liter. If the concentration of the lithium salt goes outside this range, the ionic conductivity can be undesirably low. An organic electrolyte solution containing such inorganic salts can function as a path through which lithium ions flow in one flow direction.

The organic solvent for an electrolyte solution which is suitable for the purposes of the present invention can preferably be selected from the group consisting of polyglycol ethers, oxolanes, carbonates, 2-fluorobenzene, 3-fluorobenzene, 4-fluorobenzene, dimethoxyethane, diethoxyethane and mixtures thereof.

The polyglycol ethers can be selected from the group consisting of diethylene glycol dimethyl ether (C₃(OCH₂CH₂)₂OCH₃), diethylene glycol diethyl ether (C₂H₅(OCH₂CH₂)₂OC₂H₅), triethylene glycol dimethyl ether (CH₃(OCH₂CH₂)₃OCH₃), triethylene glycol diethyl ether (C₂H₅(OCH₂CH₂)₃OC₂H₅) and mixtures thereof.

The dioxolanes can be selected from the group consisting of 1,3-dioxolane, 4,5-diethyldioxolane, 4,5-dimethyldioxolane, 4-methyl-1,3-dioxolane, 4-ethyl-1,3-dioxolane and mixtures thereof.

The carbonates can be selected from the group consisting of methylene carbonate, ethylene carbonate, diethyl carbonate, dimethyl carbonate, gamma-butyrolactone, propylene carbonate, dimethyl carbonate, methyl ethyl carbonate, diethyl carbonate, vinylene carbonate and mixtures thereof.

The organic solvent can, in one variant of the present invention, be a mixture of ethylene carbonate (EC) and dimethyl carbonate (DMC).

In a variant of the present invention, the amount of the solvent used can correspond to the amount used in a conventional lithium battery; the concentration of the lithium salt is preferably from 0.5 to 2.0 mol/l of solvent.

The separator can, for the purposes of the invention, consist of any conventional separator which is customarily used in lithium batteries. The separator should have a low resistance to the migration of ions in the electrolyte and have a high electrolyte-retention capability. The separator can, for example, be selected from the group consisting of glass fibers, polyester, polyethylene, polypropylene, polytetrafluoroethylene, carboxymethylcellulose and combinations of these materials, which can be present in woven or nonwoven form. In particular, the separator can be made up of a porous membrane composed of polyethylene and/or polypropylene which has a low reactivity toward the organic solvent.

The separator can also be a polyelectrolyte which is applied in any way to one or both electrodes before the battery is assembled. In particular, the polyelectrolyte consists of a matrix-forming polymer resin which is normally used as binder for an electrode plate. For example, the matrix-forming polymer resin can be made up of carboxymethylcellulose, vinylidene fluoride-hexafluoropropylene copolymer, polyvinylidene fluoride, polyacrylonitrile, polymethyl methacrylate, polyethylene oxide and any combination of these materials.

The matrix-forming polymer resin can also contain a filler in order to increase the mechanical strength of the polymer electrolyte. The filler can preferably consist of silicon dioxide, kaolin or aluminum. Furthermore, the matrix-forming polymer resin can contain a customary plasticizer, if desired.

The electrodes which can be used according to the present invention (anodes, cathodes) can be used in conventional lithium batteries such as primary batteries, secondary batteries and sulfur batteries. The electrodes according to the present invention can be used in lithium batteries of any shape, e.g. cylindrical, rectangular, disk-shaped or other construction types, but is not restricted thereto.

The present invention makes possible an environmentally friendly, inexpensive process for the production of battery components (cathodes, anodes) using natural cellulose as binder. A secondary lithium ion battery produced using these components displays excellent performance compared to a corresponding battery produced using synthetic binders such as PVdF or CMC.

According to the invention, environmentally harmful organic solvents and processes employed in conventional lithium battery production are replaced by nonvolatile fully recoverable ionic liquids and environmentally friendly water.

A lithium battery produced according to the present invention can accordingly find wide use as power source for portable electronic appliances such as cell phones, PDAs and notebook computers, and also for electric vehicles.

In addition, the use of the lithium battery guarantees safety and a long life of the appliances.

According to the present invention, a new binder has been found for secondary batteries known per se which have the known constituents of lithium ion cells. The sole binder for the known pulverulent electrode mixtures (consisting of the known active materials for cathodes and anodes and also conductivity improvers and for bonding to known support materials), which are used in known cell configurations with known separator materials and known electrolytes, consist of cellulose and/or cellulose derivatives which are exclusively soluble in ionic liquids, preferably cellulose, particularly preferably natural cellulose, which are dissolved in a known way in an ionic liquid. An electrode paste is produced using these solutions and applied to a support material. However, instead of the conventional evaporation of the organic solvent, the removal of the ionic liquid from the electrodes is carried out by phase inversion.

The various embodiments of the present invention, for example but not exclusively those of the various dependent claims, can be combined with one another in any way.

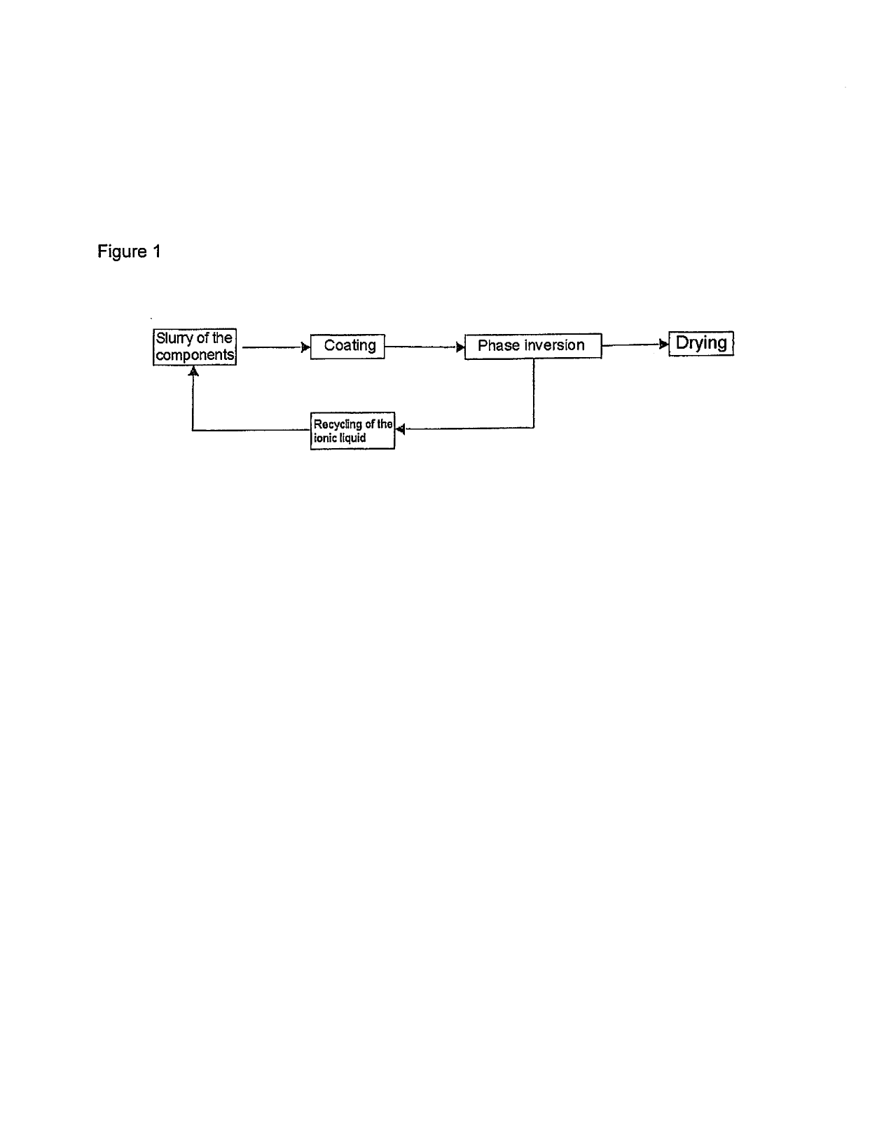

FIG. 1 illustrates the process for producing the cellulose-based battery components as set forth in examples 1 and 2.

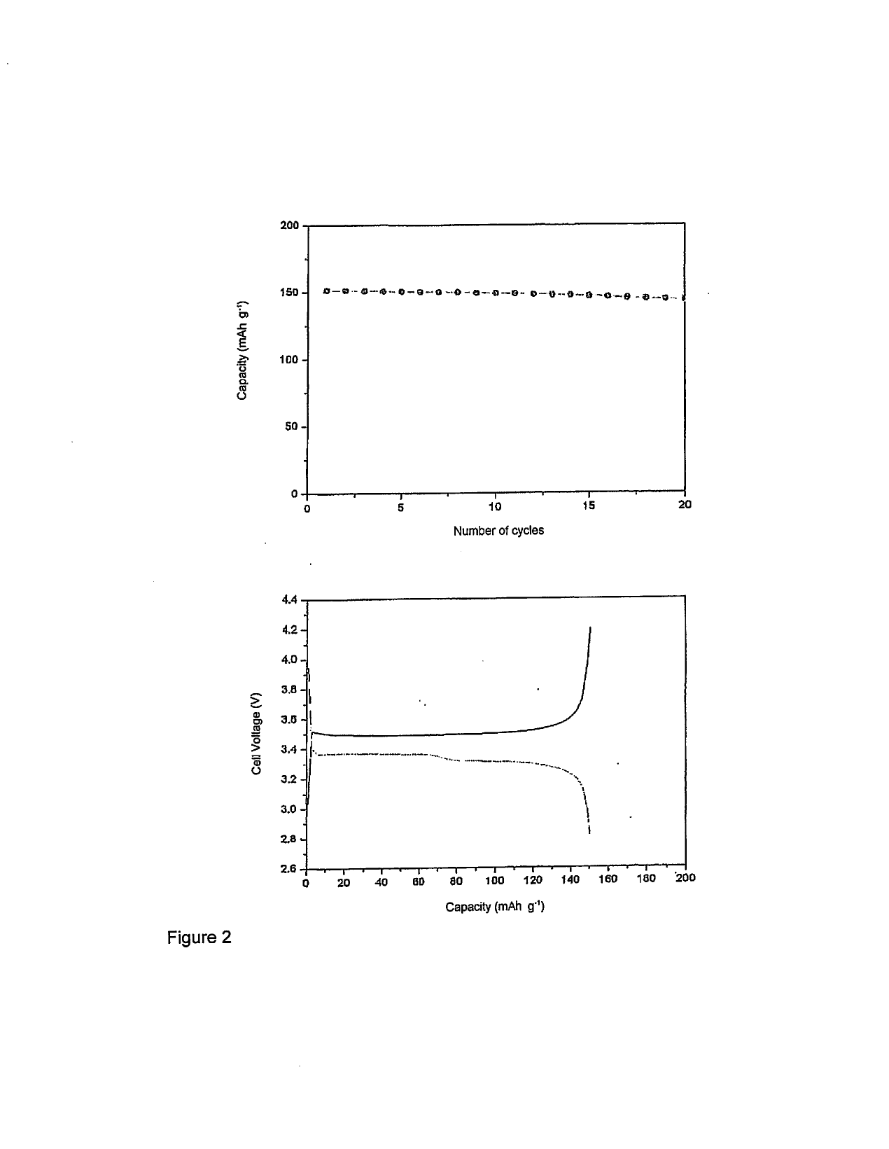

FIG. 2 illustrates the performance of a cellulose-based cathode produced as in example 1 in a lithium metal cell. The upper graph illustrates the capacity of the electrode over 20 cycles. The lower graph illustrates the voltage profile during a generic lithiation/delithiation cycle.

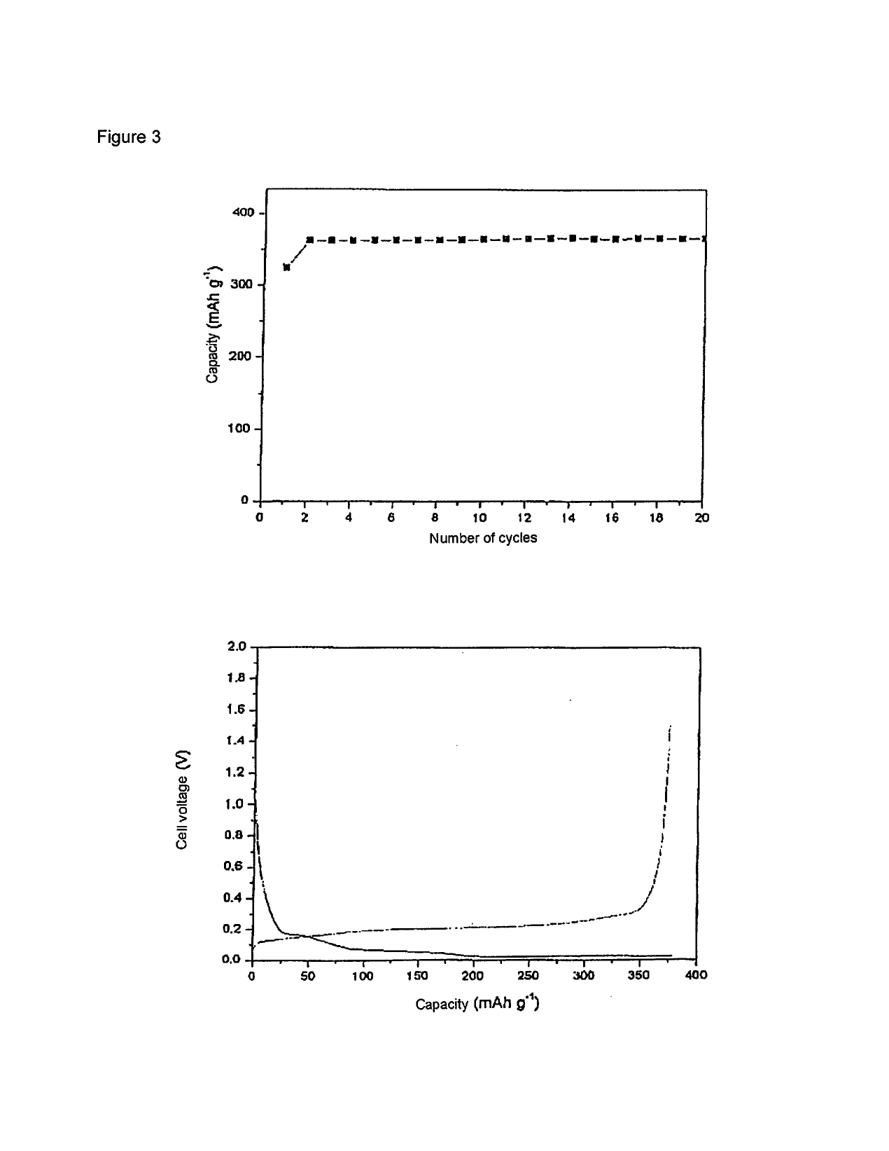

FIG. 3 illustrates the performance of a cellulose-based anode produced as described in example 2 in a lithium metal cell. The upper graph illustrates the capacity of the electrode over 20 cycles. The lower graph illustrates the voltage profile during a generic lithiation/delithiation cycle.

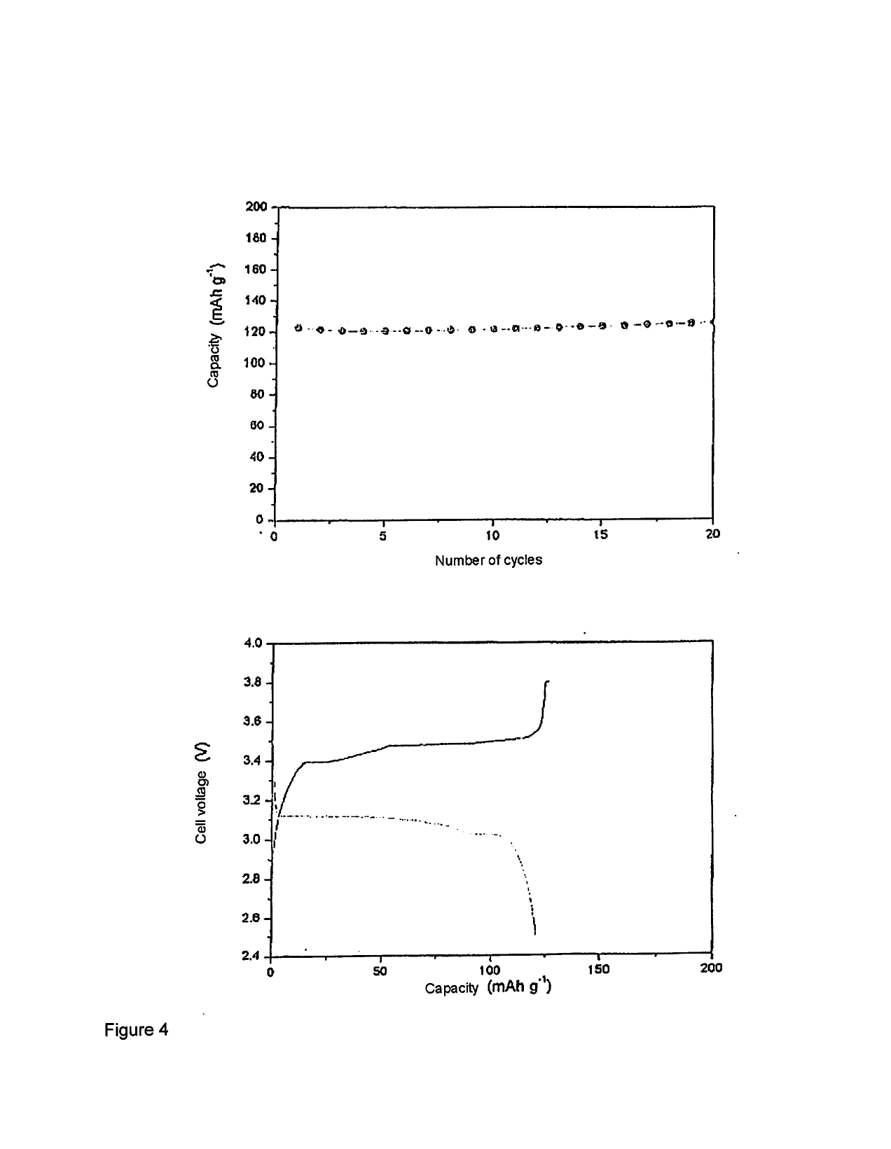

FIG. 4 illustrates the performance of a lithium battery cell produced using the components from examples 1 and 2. The upper graph illustrates the capacity of the battery over 20 cycles. The lower graph illustrates the voltage profile during a generic charging/discharging cycle.

The invention will now be illustrated with reference to the following nonlimiting examples.

### EXAMPLES

### Example 1

The following example relates to a process for producing a lithium battery cathode according to the present invention. 0.04 g of cellulose was dissolved in 1.56 g of EMIAc (BASF). 1.0 g of LiFePO₄ (Ski Chemie) and 0.107 g of conductive carbon (conductive carbon black) Ketjen Black (AKZO Nobel) were added to the cellulose solution in EMIAc. This mixture was stirred and a homogeneous slurry was formed. This slurry was applied by doctor blade coating to aluminum foil. The slurry thickness applied was set to 0.05 mm, and the application speed was set to 100 mm per second. A coated area of 200 cm² was obtained. The coated aluminum foil was introduced into water and left there for 30 minutes in order to extract EMIAc. The aluminum foil was then dried in air at 20° C. for 2 hours and then dried at 60° C. for 6 hours in order to obtain the cathode plate. The aqueous solution was filtered and the water was evaporated in order to recover all of the EMIAc.

### Example 2

The following example illustrates a process for producing a lithium battery anode according to the present invention. Cellulose was used as binder. 0.05 g of cellulose were dissolved in 1.95 g of EMIAc. 1.0 g of graphite SLP30 (TiMCAL) as active anode material and 0.05 g of conductive carbon (conductive carbon black) Super P (TIMCAL) were added to the cellulose solution in EMIAc. This mixture was stirred and a homogeneous slurry was formed. This slurry was applied by means of a doctor blade to a copper foil. The slurry thickness applied was set to 0.05 mm, and the application speed was set to 100 mm per second. A coated area of 200 cm² was obtained. The coated foil was introduced into water and kept there for 30 minutes in order to extract the EMIAc. The foil was then dried in air at 20° C. for 2 hours and then dried at 60° C. for 6 hours in order to obtain the anode plate. The aqueous solution was filtered, the water was evaporated and all of the EMIAc was recovered.

### Example 3

The following example illustrates a process for producing a lithium metal battery using the cellulose-based cathode according to the present invention. A cathode disk (12 mm diameter, likewise referred to as cathode plate) was cut from the cathode foil produced as in example 1.

A lithium metal anode was cut from a commercial lithium foil (Chemetall).

A 12 mm nonwoven glass fiber disk (Whatman) was used as separator. The separator was arranged between the cathode plate and the anode plate (lithium). The electrode assembly was placed in a T-shaped battery housing, a nonaqueous electrolyte solution was subsequently injected and the housing was then sealed in order to obtain a secondary lithium ion battery.

The nonaqueous electrolyte solution consisted of a one molar solution of LiPF₆ dissolved in a mixture of ethylene carbonate (EC) and dimethyl carbonate (DMC) in a weight ratio of 50:50.

### Example 4

The following example illustrates a process for producing a lithium ion battery using the battery components of the present invention which were obtained as described in examples 1 and 2. A cathode disk (12 mm diameter, also referred to as cathode plate) was cut from the cathode foil as described in example 1. In an analogous manner, the anode plate was cut from an anode foil as described in example 2. Both electrodes were dried at 90° C. for 10 hours in an oven.

A 12 mm nonwoven glass fiber disk (Whatman) was used as separator. The separator was placed between the cathode plate and the anode plate. The electrode assembly was placed in a T-shaped battery housing, a nonaqueous electrolyte solution was subsequently injected and the housing was then sealed in order to obtain a secondary lithium ion battery prototype.

The nonaqueous electrolyte solution consisted of a one molar solution of LiPF₆ dissolved in a mixture of ethylene carbonate (EC) and dimethyl carbonate (DMC) in a weight ratio of 50:50.

1.-8. (canceled)

9. An electrode comprising a binder comprising at least one member selected from the group consisting of cellulose and a cellulose derivative, wherein the binder is soluble only in an ionic liquid.

10. The electrode as claimed in claim 9, wherein the binder is cellulose.

11. The cathode or anode as claimed in claim 9, wherein the binder is natural cellulose.

12. The electrode as claimed in claim 9, wherein the amount of cellulose binder is in the range of from 0.1-40% by weight based on the weight of the electrode.

13. The electrode as claimed in claim 12, wherein the amount of cellulose binder is in the range of from 1-35% by weight based on the weight of the electrode.

14. The electrode as claimed in claim 13, wherein the amount of cellulose binder is in the range of from 5-25% by weight, based on the weight of the electrode.

15. A process for producing an electrode, comprising the steps of:
dissolving a binder that is soluble only in an ionic liquid in the ionic liquid to form an electrode slurry, wherein the binder is selected from the group consisting of a cellulose and a cellulose derivative, wherein the ionic liquid comprises water and an ion;
applying the electrode slurry to a substrate, removing the ionic liquid with a phase inversion process using water or an alcohol as a cosolvent.

16. The process as claimed in claim 15, wherein the binder is cellulose.

17. The process as claimed in claim 16, wherein the cellulose is natural cellulose.

18. The process as claimed in claim 15, wherein the ionic liquid comprises at least one member selected from the group consisting of is selected from the group consisting of EMIAc, EMI⁺H₂PO₂⁻ and 1-alkyl-3-methylimidazolindene acetate.

19. A battery comprising the electrode of claim 9.

20. A battery comprising the electrode of claim 10.

21. A battery comprising the electrode of claim 11.

22. The battery of claim 19, wherein the battery is a lithium battery.

23. The battery of claim 20, wherein the battery is a lithium battery.

24. The battery of claim 21, wherein the battery is a lithium battery.
